(19) United States
(12) Patent Application Publication
(10) Pub. No.: US 2024/0331961 A1
(43) Pub. Date: Oct. 3, 2024

(54) SRELAY, POWER DEVICE, POWER SUPPLY SYSTEM, AND RELAY CONTROL METHOD

(71) Applicant: Huawei Digital Power Technologies Co., Ltd., Shenzhen (CN)

(72) Inventors: Wei Wang, Shenzhen (CN); Luo Li, Xi'an (CN); Sheng Rao, Xi'an (CN); Jun Xiang, Xi'an (CN); Ruixiang Zhang, Shenzhen (CN)

(21) Appl. No.: 18/618,778

(22) Filed: Mar. 27, 2024

(30) Foreign Application Priority Data
Mar. 28, 2023 (CN) 202310370599.7

(51) Int. Cl. H01H 50/58; H01H 50/18; H01H 50/54

(52) U.S. Cl. CPC H01H 50/58; H01H 50/18; H01H 50/548

(57) ABSTRACT

A relay includes an electromagnet apparatus, a first transmission part, a second transmission part, a first elastic part, a first movable contact, a second static contact, a second elastic part, a first static contact, and a second movable contact. The first movable contact, the second static contact are both disposed on the first elastic part. The second movable contact and the first static contact are both disposed on the second elastic part. The first movable contact is in contact with or separated from the first static contact, and the second movable contact is in contact with or separated from the second static contact. When the first movable contact is in contact with the first static contact, the second movable contact is in contact with the second static contact, the first movable contact and the first static contact are in parallel with the second movable contact and the second static contact.

### CROSS-REFERENCE TO RELATED APPLICATION

This application claims priority to Chinese Patent Application NO. 202310370599.7, filed on Mar. 28, 2023, which is hereby incorporated by reference in its entirety.

### TECHNICAL FIELD

This application relates to the field of power supply system technologies, and in particular, to a relay, a power device, a power supply system, and a relay control method.

### BACKGROUND

A relay is turned on or off through contact or separation of contacts. The contacts of the relay are usually made on a spring plate. A spring plate of a conventional relay is long, which is not conducive to miniaturization of the relay.

### SUMMARY

Embodiments of this application provide a relay, a power device, a power supply system, and a relay control method, to reduce a length of a spring plate in the relay, and facilitate miniaturization of the relay.

According to a first aspect, an embodiment of this application provides a relay, including an electromagnet apparatus, a first transmission part, a second transmission part, a first elastic part, a first movable contact, a second static contact, a second elastic part, a first static contact, and a second movable contact, where the first transmission part connects the electromagnet apparatus to the first elastic part, the first movable contact is disposed at an end that is of the first elastic part and that is close to the first transmission part, and the second static contact is disposed at an end that is of the first elastic part and that is away from the first transmission part; the second transmission part connects the electromagnet apparatus to the second elastic part, the first static contact is disposed at an end that is of the second elastic part and that is away from the second transmission part, and the second movable contact is disposed at an end that is of the second elastic part and that is close to the second transmission part; and the electromagnet apparatus is configured to drive the first transmission part and the second transmission part to move, to control the first movable contact to be in contact with or be separated from the first static contact, and the second movable contact to be in contact with or be separated from the second static contact.

In this solution, the first transmission part, the second transmission part, the first elastic part, and the second elastic part are disposed, and a movable contact and a static contact are disposed on the elastic part, to provide a new relay architecture that can meet a product requirement. The first elastic part and the second elastic part are designed, a movable contact is disposed at an end of each elastic part, and a static contact is disposed at the other end, so that contact or separation of contact points can be implemented by moving of ends of two elastic parts. Because the two elastic parts may share a deformation amount required for contacting or separating the contact points together, a deformation amount of each elastic part may be small. Therefore, when a length of each elastic part is small (if the length of the elastic part is small, rigidity is large, and the elastic part is difficult to deform), a deformation requirement of each elastic part can also be met. To be specific, in this solution, the length of each elastic part may be small, which is conducive to implementing a miniaturization design of the relay, and it can be ensured that each elastic part generates a deformation amount required by the design, to implement turning on and turning off of the relay. In addition, for a working circuit, a branch circuit in which the first movable contact and the first static contact are located is connected in parallel to a branch circuit in which the second movable contact and the second static contact are located, so that total contact resistance of the working circuit can be less than contact resistance of any branch circuit. Therefore, compared with a conventional relay, the total contact resistance of the relay in this solution is small, so that a loss of the relay is small. Because the total contact resistance of the relay is small, heat generated by the relay is also small. This not only ensures reliability and a service life of the relay, but also does not need to add a complex thermal design. This helps implement miniaturization of the relay and reduce costs.

In an implementation of the first aspect, the electromagnet apparatus includes an armature and a rotating shaft: the armature and the rotating shaft form a rotating connection: the first transmission part and the second transmission part are respectively fixed at two opposite ends of the armature, and are respectively located on two opposite sides of the rotating shaft; and the armature is configured to drive the first transmission part and the second transmission part to rotate around the rotating shaft.

In this way, the first transmission part and the second transmission part are fixed on the armature, and the armature may drive the transmission part to move. The first transmission part and the second transmission part are disposed on two opposite sides of the rotating shaft, so that the first transmission part and the second transmission part rotate in a same direction. Therefore, in this solution, the electromagnet apparatus can drive the transmission part to move, so that the transmission part drives the elastic part to move, to implement contact or separation of electric shocks.

In an implementation of the first aspect, an opening distance between the first movable contact and the first static contact is less than an opening distance between the second movable contact and the second static contact.

In this solution, the opening distance between the first movable contact and the first static contact may be referred to as a first opening distance, and the opening distance between the second movable contact and the second static contact may be referred to as a second opening distance. By making the first opening distance less than the second opening distance, the first movable contact may be in contact with the first static contact first in a turning-on process of the relay, and the first movable contact may be separated from the first static contact later in a disconnecting process of the relay. The first movable contact and the second movable contact may be disposed in parallel. In this way, an electric arc may always be generated between the first movable contact and the first static contact, and is not generated between the second movable contact and the second static contact. Therefore, the electric arc is borne by the first movable contact and the first static contact, the second movable contact and the second static contact are not ablated by the electric are, and the contact resistance of the relay is always kept at a low level. This helps ensure a service life and reliability of the current contact, so that the relay has a long service life and high reliability.

In an implementation of the first aspect, the first transmission part and the second transmission part are respectively located on two opposite sides of a same axis center, the electromagnet apparatus is configured to drive the first transmission part and the second transmission part to rotate around the axis center, and a distance from an end that is of the first transmission part and that is connected to the first elastic part to the axis center is greater than a distance from an end that is of the second transmission part and that is connected to the second elastic part to the axis center; and an opening distance between the first movable contact and the first static contact is greater than an opening distance between the second movable contact and the second static contact.

In this solution, through a size design of the transmission part relative to an axis center and an adaptive design of the elastic part, when the first opening distance is greater than the second opening distance, the first movable contact and the first static contact are in contact first and then separated. The first movable contact and the second movable contact may be disposed in parallel, so that the electric arc can be borne by the first movable contact and the first static contact, and the second movable contact and the second static contact are prevented from being abated by the electric arc. This solution can meet a product design requirement.

In an implementation of the first aspect, first contact resistance between the first movable contact and the first static contact is greater than second contact resistance between the second movable contact and the second static contact. The first contact resistance is large, so that anti-arc performance of the first movable contact and the first static contact can be improved, and service lives of the first movable contact and the first static contact can be ensured.

In an implementation of the first aspect, the relay further includes a cavity and an arc chute; the arc chute, the first elastic part, the first movable contact, the second static contact, the second elastic part, the first static contact, and the second movable contact are all located in the cavity; a cavity wall of the cavity includes a channel: the channel communicates with internal and external space of the cavity; and the arc chute is located between the channel and the first movable contact. By designing the cavity and the arc chute, the electric arc can be extinguished in time, and the service life of the arcing contact can be improved.

In an implementation of the first aspect, quantities of first elastic parts and second elastic parts are both n, n is an integer greater than or equal to 3, a first movable contact and a second static contact are disposed on each first elastic part, a second movable contact and a first static contact are disposed on each second elastic part, and a first movable contact and a second static contact on one first elastic part respectively correspond to a second movable contact and a second static contact on one second elastic part.

A plurality of first elastic parts and a plurality of second elastic parts are disposed, so that the first movable contact and the second static contact are disposed on each first elastic part, and the first static contact and the second movable contact are disposed on each second elastic part. When the first transmission part and the second transmission part move, the plurality of elastic parts can be driven at the same time. Each elastic part may be connected to one phase. Therefore, the relay in this solution may be used in an n-phase system.

In an implementation of the first aspect, there are a plurality of first movable contacts and a plurality of first static contacts, and the plurality of first movable contacts are configured to be in contact with the plurality of first static contacts in a one-to-one manner; and/or there are a plurality of second movable contacts and a plurality of second static contacts, and the plurality of second movable contacts are configured to be in contact with the plurality of second static contacts in a one-to-one manner. A design of a plurality of contacts helps improve electrical connection reliability and a through-current capability.

In an implementation of the first aspect, the first elastic part and/or the second elastic part include/includes a plurality of layers of sub-elastic parts, the plurality of layers of sub-elastic parts are sequentially stacked, two ends of the plurality of layers of sub-elastic parts are fixed, and parts that are of the plurality of layers of sub-elastic parts and that are located between the two ends are not connected. The design of the plurality of layers of sub-elastic parts helps increase a through-current capability of the elastic part.

According to a second aspect, an embodiment of this application provides a power device, including a circuit board, a power conversion circuit, and a relay, where both the power conversion circuit and the relay are electrically connected to the circuit board. Because the power device in this solution includes the relay, miniaturization of the power device is implemented, reliability of the power device is improved, and costs are reduced.

According to a third aspect, an embodiment of this application provides a power supply system, including a direct current power supply and a power device, where the direct current power supply is electrically connected to a power conversion circuit in the power device. The power supply system in this solution includes the power device, and this helps implement miniaturization of the power supply system, improve reliability of the power supply system, and reduce costs.

According to a fourth aspect, an embodiment of this application provides a relay control method. A relay includes an electromagnet apparatus, a first transmission part, a second transmission part, a first elastic part, a first movable contact, a second static contact, a second elastic part, a first static contact, and a second movable contact, where the first transmission part connects the electromagnet apparatus to the first elastic part, the first movable contact is disposed at an end that is of the first elastic part and that is close to the first transmission part, the second static contact is disposed at an end that is of the first elastic part and that is away from the first transmission part, the second transmission part connects the electromagnet apparatus to the second elastic part, the first static contact is disposed at an end that is of the second elastic part and that is away from the second transmission part, and the second movable contact is disposed at an end that is of the second elastic part and that is close to the second transmission part. The control method includes: The electromagnet apparatus is controlled to drive the first transmission part and the second transmission part to move, to enable the first movable contact to be in contact with or be separated from the first static contact, and the second movable contact to be in contact with or be separated from the second static contact.

In this solution, the relay is disposed, so that a product can be miniaturized, reliability can be improved, and costs can be reduced. By controlling the relay, the relay can work in a power system.

In an implementation of the fourth aspect, the “controlling the electromagnet apparatus to drive the first transmission part and the second transmission part to move, to enable the first movable contact to be in contact with or be separated from the first static contact, and the second movable contact to be in contact with or be separated from the second static contact” includes: controlling the electromagnet apparatus to drive the first transmission part and the second transmission part to move in a first direction, so that the first movable contact is in contact with the first static contact, the second movable contact is in contact with the second static contact, and the first movable contact and the first static contact form a parallel loop with the second movable contact and the second static contact, where a moment at which the first movable contact is in contact with the first static contact is earlier than a moment at which the second movable contact is in contact with the second static contact.

In this solution, the first transmission part and the second transmission part are driven to move in the first direction, and the first movable contact is in contact with the first static contact first, so that an electric arc can be borne by the first movable contact and the first static contact, and this avoids the second movable contact and the second static contact being ablated by the electric arc.

In an implementation of the fourth aspect, the “controlling the electromagnet apparatus to drive the first transmission part and the second transmission part to move, to enable the first movable contact to be in contact with or be separated from the first static contact, and the second movable contact to be in contact with or be separated from the second static contact” includes: controlling the electromagnet apparatus to drive the first transmission part and the second transmission part to move in a second direction opposite to the first direction, so that the second movable contact is separated from the second static contact, and the first movable contact is separated from the first static contact, where a moment at which the second movable contact is separated from the second static contact is earlier than a moment at which the first movable contact is separated from the first static contact.

In this solution, the first transmission part and the second transmission part are driven to move in the second direction, and the first movable contact is separated from the first static contact later, so that the electric arc can be borne by the first movable contact and the first static contact, and this avoids the second movable contact and the second static contact being ablated by the electric arc.

### BRIEF DESCRIPTION OF DRAWINGS

FIG. 1 is a schematic diagram of a framework structure of a power supply system according to an embodiment of this application;

FIG. 2 is a schematic diagram of a structure of a relay in a turned-off state according to an embodiment:

FIG. 3 is a schematic diagram of a structure in which arcing contacts in the relay shown in FIG. 2 are in contact first:

FIG. 4 is a schematic diagram of a structure in which current contacts in the relay shown in FIG. 2 are in contact later:

FIG. 5 is a schematic diagram of a structure in which current contacts in the relay shown in FIG. 2 are first separated;

FIG. 6 is a schematic diagram of a structure of a relay in a turned-off state according to another embodiment;

FIG. 7 is a schematic diagram of a structure of a relay in a turned-off state according to another embodiment:

FIG. 8 is a partial structure of the relay shown in FIG. 2; and

FIG. 9 is a schematic diagram of a structure of the structure shown in FIG. 8 in a direction A.

### DESCRIPTION OF EMBODIMENTS

For ease of understanding, the following explains and describes related technical terms and descriptions used in embodiments of this application.

The terms “first”. “second” and the like are merely intended for a purpose of discriminate description, and shall not be understood as an indication or implication of relative importance or implicit indication of a quantity of indicated technical features. Therefore, features defined with “first”, “second”, and the like may explicitly or implicitly include one or more such features.

The term “connection” should be understood in a broad sense. For example, the “connection” may be a detachable connection, or may be a non-detachable connection: or may be a direct connection or an indirect connection through an intermediate medium. “Fixed” should also be understood in a broad sense. For example, “fixed” may be directly fixed, or may be indirectly fixed through an intermediate medium.

Unless otherwise specified, “a plurality of (layers)” means two (layers) or more (layers).

The terms such as “up”, “down”, “front”, “front”, “back”, and “back” are defined relative to orientations in which structures are schematically placed in the accompanying drawings. It should be understood that, these directional terms are relative concepts, are relative descriptions and clarifications, and may change accordingly based on a change of an orientation in which a structure is placed.

Unless otherwise specified, “and/or” is merely an association relationship for describing associated objects, and represents that three relationships may exist. For example, A and/or B may represent the following three cases: Only A exists, both A and B exist, and only B exists.

The following describes embodiments of this application with reference to the accompanying drawings in embodiments of this application.

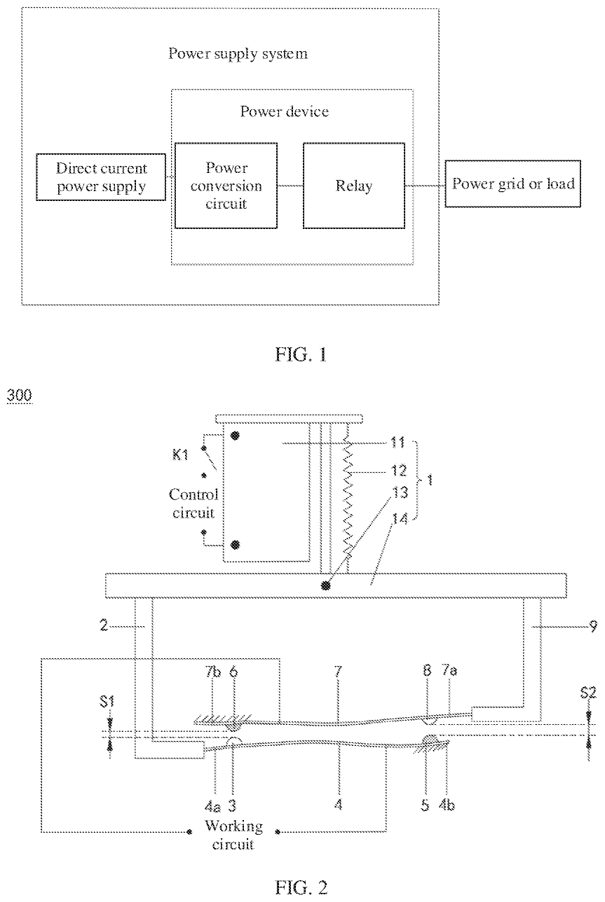

Refer to FIG. 1. An embodiment of this application provides a power supply system, and the power system may be configured to connect to a power grid or a load, and supply power to the power grid or the load. The power supply system may include a direct current power supply and a power device. The direct current power supply includes but is not limited to a photovoltaic panel, an energy storage device, and the like. The power device includes but is not limited to an inverter, a rectifier, a chopper, a charging pile, and the like. The power device may include a circuit board, a power conversion circuit, and a relay, and both the power conversion circuit and the relay are electrically connected to the circuit board. The power conversion circuit may implement functions such as voltage conversion, frequency conversion, phase conversion, and/or direct current-to-alternating current conversion. The relay may be electrically connected to the power grid or the load. When the relay is turned on, the power supply system may be connected to the power grid or the load. When a fault (for example, a power grid failure) occurs or a device in the power supply system is shut down, the relay is turned off, so that the power supply system is disconnected from the power grid or the load.

The following describes in detail the relay in embodiments of this application.

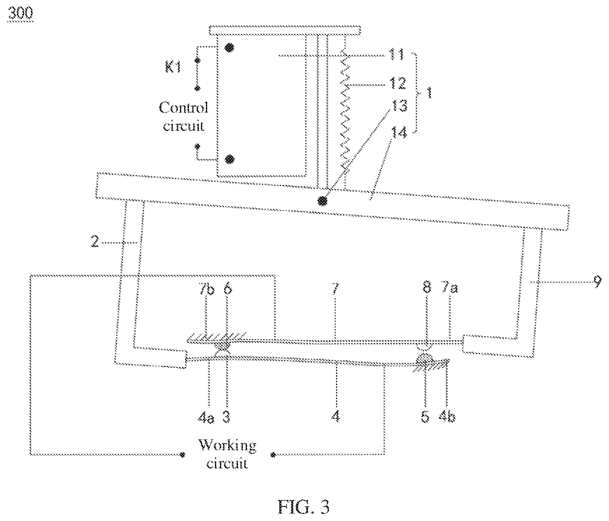

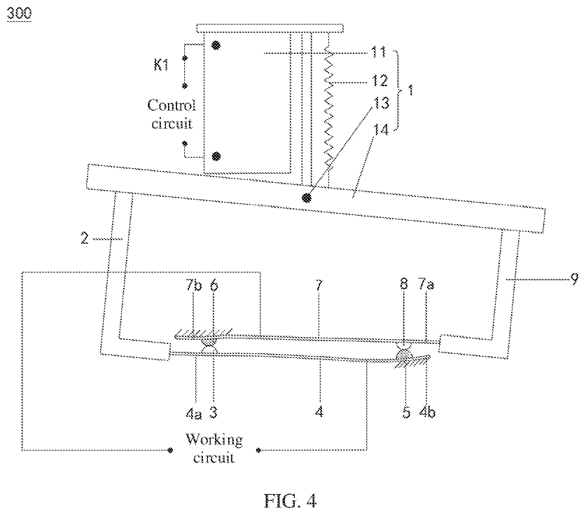

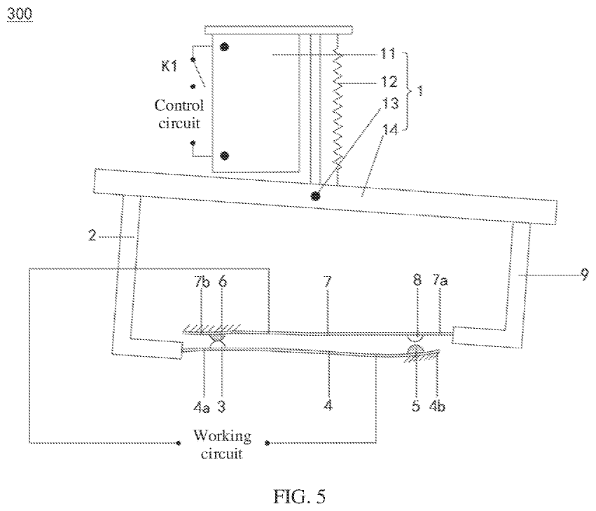

FIG. 2 is a schematic diagram of a structure of a relay 300 in a turned-off state according to this embodiment. FIG. 3 is a schematic diagram of a structure in which arcing contacts in the relay 300 is in contact first. FIG. 4 is a schematic diagram of a structure in which current contacts in the relay 300 are in contact later. FIG. 5 is a schematic diagram of a structure in which current contacts in the relay 300 are first separated.

As shown in FIG. 2, the relay 300 may include an electromagnet apparatus 1, a first transmission part 2, a second transmission part 9, a first elastic part 4, a second elastic part 7, a first movable contact 3, a second static contact 5, a first static contact 6, and a second movable contact 8.

As shown in FIG. 2, the electromagnet apparatus 1 may include a wire package 11, an armature 14, a rotating shaft 13, and a return spring 12.

The wire package 11 is connected to a control circuit of a power device, and the wire package 11 may generate a magnetic field after being powered on, and generate magnetic attachment for the armature 14. The armature 14 may be rotatively connected to the rotating shaft 13. For example, the rotating shaft 13 may be approximately disposed in the middle of the armature 14. The armature 14 may have insulation performance. The return spring 12 and the wire package 11 may be respectively located on two opposite sides of the rotating shaft 13, and the return spring 12 may be connected to the armature 14. The return spring 12 may provide a recovery force for the armature 14. As shown in FIG. 2 and FIG. 3, when the wire package 11 generates magnetic attachment for the armature 14, a magnetic force may drive the armature 14 to rotate (for example, rotate in a clockwise direction), the return spring 12 is stretched by the armature 14, and the return spring 12 may provide reverse rotating torque (for example, in a counterclockwise direction) for the armature 14.

It may be understood that the structure of the electromagnet apparatus 1 shown in FIG. 2 to FIG. 5 is merely an example, and is not a limitation on the electromagnet apparatus 1. In other embodiments, the structure of the electromagnet apparatus 1 may be designed based on a requirement.

For example, in an embodiment, a permanent magnet may be additionally disposed in the electromagnet apparatus 1. When the wire package 11 generates magnetic attachment for the armature 14, the permanent magnet adsorbs the armature 14. Even if the wire package 11 is powered off, a position of the armature 14 can remain unchanged through magnetic attachment of the permanent magnet to the armature 14, to keep the relay turned on. A relay with the permanent magnet may be referred to as a magnetic latching relay. A relay without the permanent magnet may be referred to as an electrical latching relay. To keep the relay turned on, the wire package 11 needs to be continuously powered on.

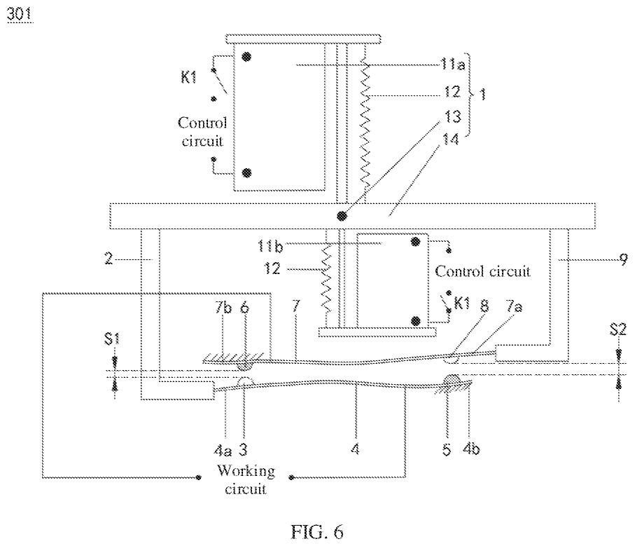

For example, in an embodiment, as shown in FIG. 6, in a relay 301, a wire package 11 in an electromagnet apparatus 1 may include a first wire package 11a and a second wire package 11b. For example, in an implementation, each wire package may be separately connected to a different control circuit. In another implementation, two wire packages may alternatively be connected to a same control circuit. The two wire packages may be respectively disposed on two sides (for example, an upper side and a lower side in a view angle of FIG. 6) of an armature 14. The two wire packages may be powered on at the same time, and magnetic force directions of the two wire packages may be opposite. Magnetic forces of the two wire packages form codirectional rotating torque for the armature 14, so that the armature 14 may rotate around a rotating shaft 13. In the embodiment shown in FIG. 6, a return spring 12 may be reserved.

Alternatively, in another embodiment, as shown in FIG. 6, the return spring 12 may be canceled. The two wire packages may be disposed on a same side (for example, the upper side in the view angle of FIG. 6) of the armature 14, magnetic force directions of the two wire packages may be opposite, and magnetic forces of the two wire packages are opposite to the rotating torque of the armature 14. When the first wire package 11a is powered on, the relay 301 may be turned on, and in this case, the second wire package 11b is powered off. When the second wire package 11b is powered on, the relay 301 is turned off, and in this case, the first wire package 11a is powered off.

Alternatively, in another embodiment, the first wire package 11a, the second wire package 11b, a first armature, and a second armature may be disposed. The first wire package 11a is configured to drive the first armature to rotate, and the second wire package 11b is configured to drive the second armature to rotate. The first wire package 11a and the second wire package 11b may be separately connected to different control circuits, or may be connected to a same control circuit. The first wire package 11a and the second wire package 11b may be powered on at the same time. A magnetic force direction of the first wire package 11a may be opposite to that of the second wire package 11b. The first wire package 11a and the second wire package 11b may drive the first armature and the second armature to rotate in a same direction. The first armature and the second armature may rotate around a same rotating shaft or different rotating shafts. The first armature is connected to a first transmission part 2, and the second armature is connected to a second transmission part 9.

As shown in FIG. 2, the first transmission part 2 and the second transmission part 9 are respectively fixed at two opposite ends of the armature 14 in the electromagnet apparatus 1, and are respectively located on two opposite sides of the rotating shaft 13. Structures of the first transmission part 2 and the second transmission part 9 may be designed based on a requirement. For example, both the first transmission part 2 and the second transmission part 9 may be in an “L” shape, and a bending part of the L shape may be away from the armature 14. Both the first transmission part 2 and the second transmission part 9 have insulation performance. The first transmission part 2 and the second transmission part 9 may also be referred to as push buckles.

As shown in FIG. 2, the first elastic part 4 and the second elastic part 7 may be stacked and arranged at an interval, and an extension direction of the first elastic part 4 and an extension direction of the second elastic part 7 may be approximately the same. The first elastic part 4 and the second elastic part 7 may be made of an elastic material having good conductivity, for example, a copper alloy. Structures of the first elastic part 4 and the second elastic part 7 may be designed based on a requirement, for example, may be a spring plate.

For example, the first elastic part 4 and/or the second elastic part 7 may be in a single-layer elastic structure. Alternatively, the first elastic part 4 and/or the second elastic part 7 may include a plurality of layers of sub-elastic parts, and the plurality of layers of sub-elastic parts are sequentially stacked. Two ends of the plurality of sub-elastic parts may be fixed (for example, fixed through welding), and parts (namely, middle parts) located between the two ends are not connected, so that the middle parts of the plurality of sub-elastic parts may be deformed. The first elastic part 4 and/or the second elastic part 7 having the plurality of layers of sub-elastic parts help/helps improve a through-current capacity of the first elastic part 4 and/or the second elastic part 7.

As shown in FIG. 2, the first elastic part 4 may include a first free end 4a and a first fixed end 4b. The first free end 4a may move under an external force, and the first fixed end 4b is fixedly disposed. The first free end 4a may be fixedly connected to the first transmission part 2.

As shown in FIG. 2, the second elastic part 7 may include a second free end 7a and a second fixed end 7b. The second free end 7a may move under an external force, and the second fixed end 7b is fixedly disposed. The second free end 7a may be fixedly connected to the second transmission part 9.

As shown in FIG. 2, the first movable contact 3 and the second static contact 5 may be arranged on the first elastic part 4 at an interval. The first movable contact 3 may be fixed at the first free end 4a of the first elastic part 4, and the second static contact 5 may be fixed at the first fixed end 4b of the first elastic part 4. Both the first movable contact 3 and the second static contact 5 may be electrically connected to the first elastic part 4. For example, a material of the first movable contact 3 may be silver tin oxide, or the like, and a material of the second static contact 5 may be pure silver or a silver alloy (for example, a silver-nickel alloy), or the like.

As shown in FIG. 2, the first static contact 6 and the second movable contact 8 may be arranged on the second elastic part 7 at an interval, the first static contact 3 may be fixed at the second fixed end 7b of the second elastic part 7, and the second movable contact 8 may be fixed at the second free end 7a of the second elastic part 7. Both the first static contact 6 and the second movable contact 8 may be electrically connected to the second elastic part 7. For example, a material of the first static contact 6 may be silver tin oxide, or the like, and a material of the second movable contact 8 may be pure silver or a silver alloy (for example, a silver-nickel alloy), or the like. In this embodiment, a movable contact and a static contact are arranged on each elastic part, and a spacing between a movable contact and a static contact on a same spring plate may be, for example, approximately 30 mm.

In this embodiment, the first movable contact 3 and the first static contact 6 are a pair of working contacts. The first movable contact 3 may be in contact with or be separated from the first static contact 6. The first movable contact 3 and the first static contact 6 may be collectively referred to as arcing contacts, and the arcing contacts are mainly configured to bear electric arcs. The second movable contact 8 and the second static contact 5 are a pair of working contacts. The second movable contact 8 may be in contact with or be separated from the second static contact 5. The second movable contact 8 and the second static contact 5 may be collectively referred to as a current contact, and the current contact is mainly configured to implement through-current. First contact resistance between the first movable contact 3 and the first static contact 6 may be greater than second contact resistance between the second movable contact 8 and the second static contact 5. The foregoing content is further described below.

As shown in FIG. 2, a first opening distance S1 (an opening distance refers to a minimum distance between a movable contact and a static contact when the relay is turned off) between the first movable contact 3 and the first static contact 6 may be less than a second opening distance S2 between the second movable contact 8 and the second static contact 5. For example, an opening distance difference between the first opening distance S1 and the second opening distance S2 may be approximately 2 mm to 3 mm.

In this embodiment, there may be one or more first movable contacts 3 and one or more first static contacts 6. When there are a plurality of first movable contacts 3 and a plurality of first static contacts 6, one first movable contact 3 corresponds to one first static contact 6. There may be one or more second movable contacts 8 and one or more second static contacts 5. When there are a plurality of second movable contacts 8 and a plurality of second static contacts 5, one second movable contact 8 corresponds to one second static contact 5. A design of a plurality of contacts helps improve electrical connection reliability and a through-current capability.

The foregoing describes a basic structure of the relay 300 with reference to FIG. 2 to FIG. 5. The following describes a working principle of the relay 300 with reference to FIG. 2 to FIG. 5.

When the power device needs to be connected to a power grid or a load, the power device may generate a first control signal, and the first control signal may trigger the relay 300 to be turned on. When a fault occurs (for example, a power grid failure occurs), or a device in the power supply system is powered off, the power device may send a second control signal, and the second control signal may trigger the relay 300 to be turned off. For example, the first control signal and the second control signal may be generated and sent by a control module (for example, a main control card) in the power device.

FIG. 2 indicates that the relay 300 is in a turned-off state. As shown in FIG. 2, two pins of the wire package 11 may be separately connected to two ends of a control circuit, two ends of a working circuit may be separately connected to the first elastic part 4 and the second elastic part 7, and the working circuit is a circuit that connects the relay 300 and the power grid or the load.

With reference to FIG. 2 and FIG. 3, when triggered by the first control signal of the power device, a control switch K1 in the control circuit may change from turning off to turning on, the control circuit is turned on, and the wire package 11 in the electromagnet apparatus 1 is energized and may generate an electromagnetic field. Driven by a magnetic field force, the armature 14 may rotate around the rotating shaft 13 in a clockwise direction. In a rotation process of the armature 14, the return spring 12 is stretched and provides a recovery force for the armature 14. The armature 14 may drive the first transmission part 2 and the second transmission part 9 connected to the armature 14 to rotate around the rotating shaft 13 in a clockwise direction. The first transmission part 2 may drive the first free end 4a of the first elastic part 4 to approach the second fixed end 7b of the second elastic part 7, and the second transmission part 9 may drive the second free end 7a of the second elastic part 7 to approach the first fixed end 4b of the first elastic part 4. In a process in which the first transmission part 2 and the second transmission part 9 drive the first elastic part 4 and the second elastic part 7 to move, the first elastic part 4 and the second elastic part 7 undergo elastic deformation. Because the first opening distance S1 between the first movable contact 3 and the first static contact 6 is less than the second opening distance S2 between the second movable contact 8 and the second static contact 5, the first movable contact 3 may be in contact with the first static contact 6 first, and the second movable contact 8 and the second static contact 5 are not in contact with each other when the first movable contact 3 is in contact with the first static contact 6. When the first movable contact 3 is in contact with the first static contact 6, the working circuit is turned on.

As shown in FIG. 4, as the armature 14 continues to rotate, the first transmission part 2 and the second transmission part 9 continue to rotate, and the first elastic part 4 and the second elastic part 7 may continue to undergo elastic deformation. In this case, because the first movable contact 3 on the first elastic part 4 is in contact with the first static contact 6, when the first transmission part 2 drives the first free end 4a, the first movable contact 3 is in an overtravel state. As the second transmission part 9 continues to rotate, the second elastic part 7 may drive the second free end 7a to move, so that the second movable contact 8 is in contact with the second static contact 5. In this case, the first movable contact 3 and the first static contact 6 form a parallel loop with the second movable contact 8 and the second static contact 5.

In this embodiment, in a process in which the relay 300 is turned on, the first movable contact 3 is in contact with the first static contact 6 first, and then the second movable contact 8 is in contact with the second static contact 5. With reference to FIG. 3 and FIG. 4, an electric arc (namely, an arc) is generated between the first movable contact 3 and the first static contact 6 at a moment when the first movable contact 3 is in contact with the first static contact 6. At a moment when the second movable contact 8 is in contact with the second static contact 5, because the first movable contact 3 is in contact with the first static contact 6, the working circuit is turned on. Therefore, the second movable contact 8 and the second static contact 5 are short-circuited, and a voltage difference between the second movable contact 8 and the second static contact 5 is basically zero. Therefore, no are is formed between the second movable contact 8 and the second static contact 5.

Therefore, in a process in which the relay 300 is turned on, the electric arc is borne by the arcing contacts (the first movable contact 3 and the first static contact 6) and the current contacts (the second movable contact 8 and the second static contact 5) are not abated by the electric arc. With reference to FIG. 4 and FIG. 5, when triggered by the second control signal of the power device, a control switch K1 in the control circuit may change from turning on to turning off, the control circuit is turned off, and the wire package 11 in the electromagnet apparatus 1 is out of energize and does not generate an electromagnetic field. The return spring 12 is reset gradually from a stretching state, and provides a recovery force for the armature 14, so that the armature 14 rotates around the rotating shaft 13 in a counterclockwise direction. In a rotating process of the armature 14 in a counterclockwise direction, the first transmission part 2 and the second transmission part 9 may be driven to rotate around the rotating shaft 13 in a counterclockwise direction. The first transmission part 2 may drive the first free end 4a of the first elastic part 4 to be away from the second fixed end 7b of the second elastic part 7, and the second transmission part 9 may drive the second free end 7a of the second elastic part 7 to be away from the first fixed end 4b of the first elastic part 4. In a process in which the first transmission part 2 and the second transmission part 9 drive the first elastic part 4 and the second elastic part 7 to move, the first elastic part 4 and the second elastic part 7 gradually recover from a deformed state to an original state. When the second movable contact 8 is in contact with the second static contact 5, the first movable contact 3 and the first static contact 6 are in an overtravel state. Therefore, in a process in which the first elastic part 4 and the second elastic part 7 are restored to the original state, the second movable contact 8 is first separated from the second static contact 5. With reference to FIG. 5 and FIG. 2, after the second movable contact 8 is separated from the second static contact 5, the first movable contact 3 is separated from the first static contact 6. As shown in FIG. 2, when the first movable contact 3 is separated from the first static contact 6, the working circuit is turned off.

It may be understood that the first transmission part 2 and the second transmission part 9 rotate in a clockwise direction or a counterclockwise direction, which are both schematic descriptions based on the figures. In this embodiment, a rotation direction of the first transmission part 2 and the second transmission part 9 in a process of turning on the relay 300 may be referred to as a first direction, and a rotation direction of the first transmission part 2 and the second transmission part 9 in a process of disconnecting the relay 300 may be referred to as a second direction. The second direction and the first direction are opposite directions.

In this embodiment, in a process in which the relay 300 is turned off, the second movable contact 8 is separated from the second static contact 5 first, and then the first movable contact 3 is separated from the first static contact 6. With reference to FIG. 5 and FIG. 2, at a moment when the second movable contact 8 is separated from the second static contact 5, because the first movable contact 3 is still in contact with the first static contact 6, the working circuit remains turned on. Therefore, the second movable contact 8 and the second static contact 5 are short-circuited, and a voltage difference between the second movable contact 8 and the second static contact 5 is basically zero. Therefore, no are is formed between the second movable contact 8 and the second static contact 5. When the first movable contact 3 is separated from the first static contact 6, an arc is formed between the first movable contact 3 and the first static contact 6.

Therefore, in a process in which the relay 300 is turned off, the electric are is borne by the arcing contacts (the first movable contact 3 and the first static contact 6) and the current contacts (the second movable contact 8 and the second static contact 5) are not abated by the electric arc.

In conclusion, in a process of turning on and turning off the relay 300, an electric arc is always generated between the arcing contacts, and is not generated between the current contacts. Therefore, the electric arc is borne by the arcing contacts, the current contacts are not burnt by the electric arc, and contact resistance of the relay 300 is always kept at a low level. This helps ensure a service life and reliability of the current contact, so that the relay 300 has a long service life and high reliability. In addition, as described above, to improve anti-arc performance of the arcing contacts, a contact material is doped with an anti-arc material. Therefore, contact resistance between the arcing contacts is large.

In addition, for the working circuit, a branch circuit on which the arcing contact is located and a branch circuit on which the current contact is located are connected in parallel, so that total contact resistance of the working circuit can be less than contact resistance of any branch circuit. Therefore, compared with a conventional relay, the total contact resistance of the relay 300 in this embodiment is small, so that a loss of the relay 300 is small. In addition, because the total contact resistance of the relay 300 is small, heat generated by the relay 300 is also small. This not only ensures reliability and a service life of the relay 300, but also does not need to add a complex thermal design. This helps implement miniaturization of the relay and reduce costs.

In this embodiment, the first elastic part 4 and the second elastic part 7 are designed, a movable contact is disposed at a free end of each elastic part, and a static contact is disposed at a fixed end, so that the arcing contact and the current contact can be in contact with or be separated by moving the free ends of the two elastic parts. Because the two elastic parts may share a deformation amount required for contacting or separating the contact points together, a deformation amount of each elastic part may be small. Therefore, when a length of each elastic part is small (if the length of the elastic part is small, rigidity is large, and the elastic part is difficult to deform), a deformation requirement of each elastic part can also be met. To be specific, in this solution in this embodiment, the length of each elastic part may be small, which is conducive to implementing a miniaturization design of the relay 300, and it can be ensured that each elastic part generates a deformation amount required by the design, to implement turning on and turning off of the relay 300.

As described above, the first opening distance S1 between the arcing contacts may be less than the second opening distance S2 between the current contacts, so that in a turning-on process of the relay 300, the arcing contacts are first in contact and then the current contacts are in contact. In a connecting process of the relay 300, the current contacts are first separated and then the arcing contacts are separated. In another embodiment, the first opening distance S1 between the arcing contacts may also be greater than the second opening distance S2 between the current contacts, and a structure design is performed on a transmission part and an elastic part, to ensure that the arcing contacts are first contacted and then separated, and the current contacts are first contacted and then separated. Description is made in the following.

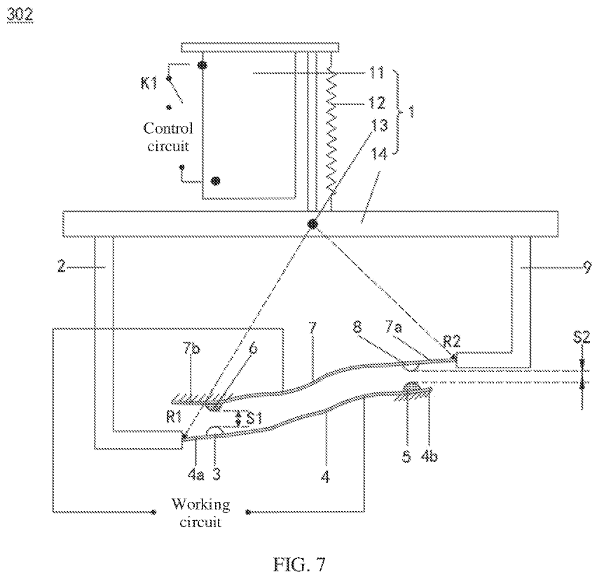

As shown in FIG. 7, in an embodiment, a first transmission part 2 and a second transmission part 9 of a relay 302 are separately disposed on two opposite sides of an axis center (the axis center is a rotating shaft 13, or a center line of a rotating shaft 13) of an armature 14. The first transmission part 2 may be longer, so that a first distance R1 from an end that is of the first transmission part 2 and that is connected to a first free end 4a to the axis center is greater than a second distance R2 from an end that is of the second transmission part 9 and that is connected to a second free end 7a to the axis center. An adaptive structure design may be performed on a first elastic part 4, so that a spacing between the first free end 4a and a second fixed end 7b of a second elastic part 7 is large, and a first opening distance S1 between arcing contacts is greater than a second opening distance S2 between current contacts. A difference between the first distance R1 and the second distance R2 and a difference between the first opening distance S1 and the second opening distance S2 may be matched based on a product requirement.

In this embodiment, both the first transmission part 2 and the second transmission part 9 may rotate around the axis center, and the first distance R1 is greater than the second distance R2. Therefore, a linear velocity of rotation of an end that is of the first transmission part 2 and that is connected to the first free end 4a is large, and a linear velocity of rotation of an end that is of the second transmission part 9 and that is connected to the second free end 7a is small. The difference between the first distance R1 and the second distance R2 and the difference between the first opening distance S1 and the second opening distance S2 are properly designed, so that when the first opening distance S1 is greater than the second opening distance S2, an end that is of the first transmission part 2 and that is connected to the first free end 4a first reaches a position at which the arcing contacts are contacted or separated, thereby implementing that the arcing contacts are first contacted and then separated.

In the foregoing embodiment, to protect the arcing contact, an air pressure arc extinguishing apparatus may be added near the arcing contact, to extinguish an electric arc and improve a service life of the arcing contact. Description is made in the following.

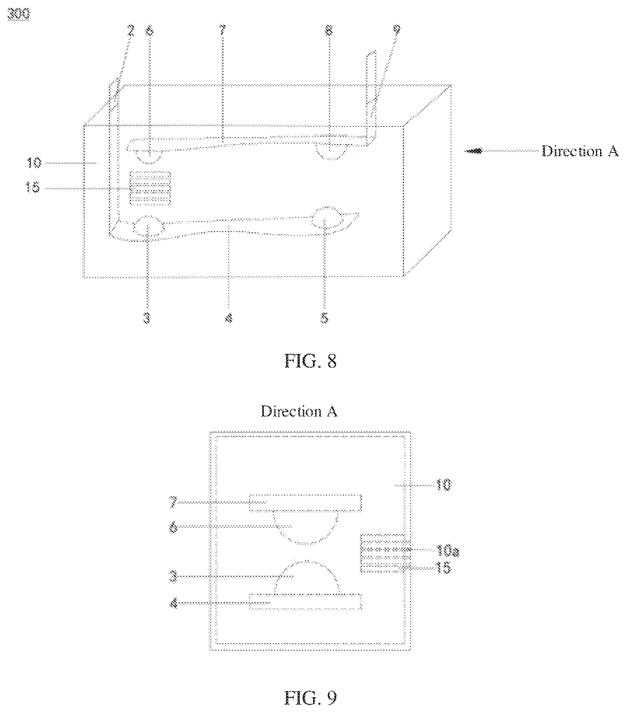

FIG. 8 shows a partial structure of a relay 300. FIG. 9 is a schematic diagram of a structure shown in FIG. 8 in an A direction. As shown in FIG. 8 and FIG. 9, the relay 300 may include a cavity 10, and the cavity 10 may be enclosed, for example, by a housing or another structural part of the relay 300. A cavity wall of the cavity 10 is provided with a channel 10a that communicates internal and external space of the cavity 10. There is no other opening hole on the cavity wall except the channel 10a. A first elastic part 4, a first movable contact 3, a second static contact 5, a second elastic part 7, a first static contact 6, and a second movable contact 8 are all located in the cavity 10. A part of a first transmission part 2 and a second transmission part 9 may also be located in the cavity 10. An arc chute 15 may be disposed in the cavity 10, and the arc chute 15 may be close to the channel 10a, and may be close to the first movable contact 3 and the second static contact 5. The arc chute 15 may be located between the first movable contact 3 (or the second static contact 5) and the channel 10a. The arc chute 15 may include, for example, several arc chute plates that are arranged in a stacked manner at intervals.

Refer to FIG. 9. In a high-current arc extinguishing scenario, when an arc is formed between the first movable contact 3 and the first static contact 6, air in the cavity 10 is heated by the electric arc, so that air pressure in the cavity 10 increases, the air flows out of the cavity 10 from the channel 10a to form an airflow, the airflow blows the electric are to the arc chute 15, and the arc chute 15 extinguishes the electric arc.

For example, the relay 300 in this embodiment may be used in a single-phase system or a multi-phase system, and the multi-phase system may be, for example, a three-phase three-wire system or a three-phase four-wire system. When the relay 300 is used in the multi-phase system, there may be n first elastic parts 4 connected to the first transmission part 2, where n≥1, the n first elastic parts 4 may be arranged side by side, the n first elastic parts 4 may move synchronously, and a design of a movable contact and a static contact on each first elastic part 4 may be the same. There may be n second elastic parts 7 connected to the second transmission part 9, the n second elastic parts 7 may be arranged side by side, the n second elastic parts 7 may move synchronously, and a design of a movable contact and a static contact on each second elastic part 7 may be the same.

In this embodiment, a first movable contact 3 and a second movable contact 5 on a first elastic part 4 correspond to a first static contact 6 and a second movable contact 8 on a second elastic part 7, that is, the first movable contact 3 on the first elastic part 4 and the first static contact 6 on the second elastic part 7 are used as arcing contacts, and the second static contact 5 on the first elastic part 4 and the second movable contact 8 on the second elastic part 7 are used as current contacts. Such an arcing contact and a current contact both have n groups. In each group of arcing contacts or each group of current contacts, a quantity of movable contacts (or static contacts) may be one or more. When the first transmission part 2 and the second transmission part 9 rotate, the n groups of arcing contacts may be in contact or separated simultaneously, the n groups of current contacts may be in contact or separated simultaneously, and the arcing contacts are in contact first and then separated, and the current contacts are in contact first and then separated.

The foregoing descriptions are merely specific implementations of this application, but are not intended to limit the protection scope of this application. Any variation or replacement readily figured out by a person skilled in the art in the technical scope disclosed on in this application shall fall within the protection scope of this application. Therefore, the protection scope of this application shall be subject to the protection scope of the claims.

What is claimed is:

1. A relay, comprising:
an electromagnet apparatus, a first transmission part, a second transmission part, a first elastic part, a first movable contact, a second static contact, a second elastic part, a first static contact, and a second movable contact, wherein
the first transmission part connects the electromagnet apparatus to the first elastic part, the first movable contact is disposed at an end that is of the first elastic part and that is close to the first transmission part, and the second static contact is disposed at an end that is of the first elastic part and that is away from the first transmission part;
the second transmission part connects the electromagnet apparatus to the second elastic part, the first static contact is disposed at an end that is of the second elastic part and that is away from the second transmission part, and the second movable contact is disposed at an end that is of the second elastic part and that is close to the second transmission part; and
the electromagnet apparatus is configured to drive the first transmission part and the second transmission part to move, to control the first movable contact to be in contact with or be separated from the first static contact and the second movable contact to be in contact with or be separated from the second static contact.

2. The relay according to claim 1, wherein
the electromagnet apparatus comprises an armature and a rotating shaft; the armature and the rotating shaft form a rotating connection; the first transmission part and the second transmission part are respectively fixed at two opposite ends of the armature, and are respectively located on two opposite sides of the rotating shaft; and the armature is configured to drive the first transmission part and the second transmission part to rotate around the rotating shaft.

3. The relay according to claim 1, wherein
an opening distance between the first movable contact and the first static contact is less than an opening distance between the second movable contact and the second static contact.

4. The relay according to claim 1, wherein
the first transmission part and the second transmission part are respectively located on two opposite sides of a same axis center, the electromagnet apparatus is configured to drive the first transmission part and the second transmission part to rotate around the axis center, and a distance from an end that is of the first transmission part and that is connected to the first elastic part to the axis center is greater than a distance from an end that is of the second transmission part and that is connected to the second elastic part to the axis center, and
an opening distance between the first movable contact and the first static contact is greater than an opening distance between the second movable contact and the second static contact.

5. The relay according to claim 1, wherein
first contact resistance between the first movable contact and the first static contact is greater than second contact resistance between the second movable contact and the second static contact.

6. The relay according to claim 1, wherein
the relay further comprises a cavity and an arc chute; the arc chute, the first elastic part, the first movable contact, the second static contact, the second elastic part, the first static contact, and the second movable contact are all located in the cavity; a cavity wall of the cavity comprises a channel; the channel communicates internal and external space of the cavity; and the are chute is located between the channel and the first movable contact.

7. The relay according to claim 1, wherein
quantities of first elastic parts and second elastic parts are both n, n is an integer greater than or equal to 3, the first movable contact and the second static contact are disposed on each first elastic part, the second movable contact and the first static contact are disposed on each second elastic part, and the first movable contact and the second static contact on one first elastic part respectively correspond to the second movable contact and the second static contact on one second elastic part.

8. The relay according to claim 1, wherein
there are a plurality of first movable contacts and a plurality of first static contacts, and the plurality of first movable contacts are configured to be in contact with the plurality of first static contacts in a one-to-one manner; and/or there are a plurality of second movable contacts and a plurality of second static contacts, and the plurality of second movable contacts are configured to be in contact with the plurality of second static contacts in a one-to-one manner.

9. The relay according to claim 1, wherein
the first elastic part and/or the second elastic part comprise/comprises a plurality of layers of sub-elastic parts, the plurality of layers of sub-elastic parts are sequentially stacked, two ends of the plurality of layers of sub-elastic parts are fixed, and parts that are of the plurality of layers of sub-elastic parts and that are located between the two ends are not connected.

10. A power device, comprising:
a circuit board, a power conversion circuit, and the relay according to claim 1, wherein both the power conversion circuit and the relay are electrically connected to the circuit board.

11. A power supply system, comprising:
a direct current power supply and the power device according to claim 10, wherein the direct current power supply is electrically connected to a power conversion circuit in the power device.

12. A relay control method, wherein
a relay comprises an electromagnet apparatus, a first transmission part, a second transmission part, a first elastic part, a first movable contact, a second static contact, a second elastic part, a first static contact, and a second movable contact, wherein the first transmission part connects the electromagnet apparatus to the first elastic part, the first movable contact is disposed at an end that is of the first elastic part and that is close to the first transmission part, the second static contact is disposed at an end that is of the first elastic part and that is away from the first transmission part, the second transmission part connects the electromagnet apparatus to the second elastic part, the first static contact is disposed at an end that is of the second elastic part and that is away from the second transmission part, and the second movable contact is disposed at an end that is of the second elastic part and that is close to the second transmission part; and
the control method comprises:
controlling the electromagnet apparatus to drive the first transmission part and the second transmission part to move, to enable the first movable contact to be in contact with or be separated from the first static contact and the second movable contact to be in contact with or be separated from the second static contact.

13. The control method according to claim 12, wherein
the controlling the electromagnet apparatus to drive the first transmission part and the second transmission part to move, to enable the first movable contact to be in contact with or be separated from the first static contact, and the second movable contact to be in contact with or be separated from the second static contact comprises:
controlling the electromagnet apparatus to drive the first transmission part and the second transmission part to move in a first direction, so that the first movable contact is in contact with the first static contact, the second movable contact is in contact with the second static contact, and the first movable contact and the first static contact form a parallel loop with the second movable contact and the second static contact, wherein a moment at which the first movable contact is in contact with the first static contact is earlier than a moment at which the second movable contact is in contact with the second static contact.

14. The control method according to claim 12, wherein
the controlling the electromagnet apparatus to drive the first transmission part and the second transmission part to move, to enable the first movable contact to be in contact with or be separated from the first static contact, and the second movable contact to be in contact with or be separated from the second static contact comprises:
controlling the electromagnet apparatus to drive the first transmission part and the second transmission part to move in a second direction opposite to the first direction, so that the second movable contact is separated from the second static contact, and the first movable contact is separated from the first static contact, wherein a moment at which the second movable contact is separated from the second static contact is earlier than a moment at which the first movable contact is separated from the first static contact.
